(19) United States
(12) Patent Application Publication
(10) Pub. No.: US 2019/0135985 A1
(43) Pub. Date: May 9, 2019

(54) Polyoxymethylene and Siloxane Block Copolymers and Process For Making Same

(71) Applicant: Celanese Sales Germany GmbH, Sulzbach (DE)

(72) Inventor: André Hebel, Sprendlingen (DE)

(21) Appl. No.: 16/183,059

(22) Filed: Nov. 7, 2018

Related U.S. Application Data
(60) Provisional application No. 62/582,614, filed on Nov. 7, 2017.

(51) Int. Cl. C08G 77/46

(52) U.S. Cl. CPC C08G 77/46

(57) ABSTRACT

Polyoxymethylene-polydimethysiloxane block copolymers are disclosed. In one embodiment, the siloxane monomer used to make the polymer is soluble in the polyoxymethylene monomers, namely trioxane. The polymer can be formed having relatively small particle sizes, such as less than about 350 microns, such as less than about 200 microns, which makes the polymer well suited for powder coating applications.

### RELATED APPLICATIONS

The present application is based upon and claims priority to U.S. Provisional Patent Application Ser. No. 62/582,614, filed on Nov. 7, 2017, which is incorporated herein by reference.

### BACKGROUND

Polyacetal polymers, which are commonly referred to as polyoxymethylenes (POMs), have become established as exceptionally useful engineering materials in a variety of applications. POMs for instance, are widely used in constructing molded parts, such as parts for use in the automotive industry and the electrical industry. POMs, for instance, have excellent mechanical property, fatigue resistance, abrasion resistance, chemical resistance, and moldability.

In the past, various attempts have been made in order to improve the properties of polyoxymethylene polymers by blending the polymers with various additives. For example, in the past, polyoxymethylene polymers have been combined with tribological additives for producing polymer compositions and polymer articles well suited for use in applications where the article is in moving contact with other articles. Tribological additives that have been proposed in the past include, for instance, silicones, polysiloxanes, waxes, and the like. The tribological additives can reduce the coefficient of friction of the polymer and can make the polymer more resistant to wear.

In order to increase the impact resistance of polyoxymethylene polymers, the polymers have also been combined in the past with various impact modifiers. Impact modifiers that have been used in the past include, for instance, thermoplastic elastomers and core and shell Impact modifiers. The impact modifiers increase the impact resistance of the polymers.

Although combining additives with polyoxymethylene polymers can provide polymer compositions and polymer articles with an excellent balance of properties, improvements are still needed. For example, a need exists for a method of chemically modifying polyoxymethylene polymers for Improving the inherent properties of the polymers. A need also exists for chemically modified polyoxymethylene polymers that have an improved balance of properties.

### SUMMARY

In general, the present disclosure is directed to polyoxymethylene polymers that have been chemically modified with a siloxane to improve at least one property of the polymer. For example, in one embodiment, the present disclosure is directed to a polyoxymethylene-polydimethylsiloxane block copolymer having excellent impact strength properties and elongation properties in combination with excellent slip wear properties.

In one embodiment, the present disclosure is directed to a polyoxymethylene-siloxane block copolymer having the following formula:

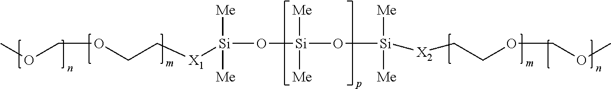

wherein n is from about 5 to about 1500, m is from 2 to 10, p is from 5 to 500, such as from about 15 to about 200, and wherein

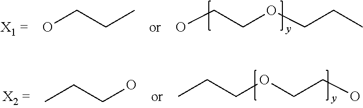

and wherein y is from about 5 to about 50;
or

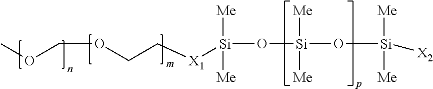

wherein n is from about 5 to about 1500, m is from 2 to 10, p is from 5 to 500, such as from about 15 to about 200, and wherein

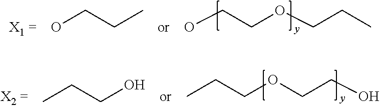

and wherein y is from about 5 to about 50.

The above block copolymer can be synthesized to have an excellent balance of properties. For instance, the polymer can have excellent elongation properties.

The amount of polydimethylsiloxane units within the copolymer can vary depending upon the particular application and the desired result. In general, the polydimethylsiloxane groups can be present in the polymer in an amount greater than about 0.1% by weight, such as in an amount greater than about 0.5% by weight, such as in an amount greater than about 1% by weight, such as in an amount greater than about 2% by weight, such as in an amount greater than about 3% by weight, such as in an amount greater than about 4% by weight, such as in an amount greater than about 5% by weight. The polydimethylsiloxane groups are generally present in an amount less than about 20% by weight, such as in an amount less than about 15% by weight, such as in an amount less than about 10% by weight, such as in an amount less than about 8% by weight.

In one embodiment, the polyoxymethylene and siloxane block copolymer is made by combining a first monomer that forms —CH₂—O— units with a second monomer comprising a siloxane including carbinol groups or ethylene oxide groups. In one embodiment, a third monomer may be present. The third monomer may comprise dioxolane. In accordance with the present disclosure, the monomers are polymerized to form a polyoxymethylene-siloxane block copolymer.

In one embodiment, the second monomer Is selected so as to be soluble in the first monomer. The first monomer, for instance, may comprise trioxane, tetraoxane, or mixtures thereof. The second monomer, on the other hand, may comprise a polydimethylsiloxane formal. For instance, the second monomer may comprise a polyethylene oxide-b-dimethylsiloxane-polyethylene oxide. For instance, the second monomer may have the following formula:

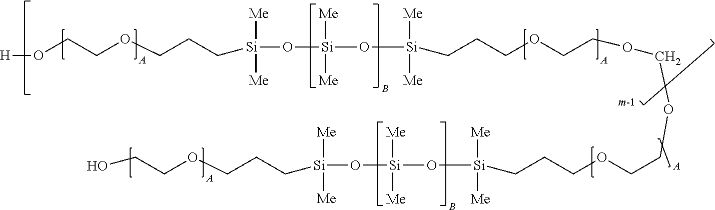

and wherein A is from about 2 to about 50, such as from about 2 to about 35, such as from about 8 to about 20; B is from about 5 to about 500, such as from about 5 to about 200, such as from about 7 to about 75; and m is from about 2 to about 10.

In an alternative embodiment, the second monomer may have the following formula:

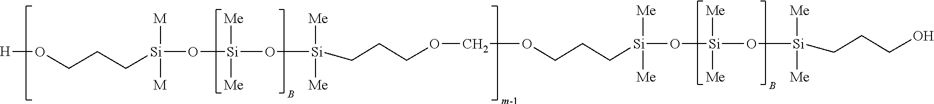

and wherein B is from about 5 to about 500, such as from about 5 to about 200, such as from about 7 to about 75; and m is from about 2 to about 10.

In one embodiment, the process further comprises the step of adding a deactivator to deactivate the polymerization. In accordance with the present disclosure, the block copolymer formed through the process can be formed through a substantially homogeneous polymer melt when the deactivator is added.

Polymerization can occur in the presence of any suitable catalyst, such as trifluoremethanesulfonic acid, a heteropoly acid or an ion exchange resin. Of particular advantage, polymerization can occur with a very short induction period. The induction period, for instance, can be less than about 100 seconds, such as less than about 80 seconds, such as less than about 60 seconds, such as less than about 40 seconds. The induction period is generally greater than about 4 seconds, such as greater than about 10 seconds.

The polyoxymethylene-based polymer can also be made with a relatively small particle size. For instance, the polymer can have a d50 particle size of less than about 350 microns, such as less than about 200 microns, such as less than about 150 microns. The d50 particle size is generally greater than about 20 microns, such as greater than about 50 microns. The above particle sizes make the polymer well suited for use in powder coating applications. For instance, the particles having the above sizes can be heated and used to coat metal substrates.

Other features and aspects of the present disclosure are discussed in greater detail below.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to polyoxymethylene copolymers that include siloxane, particularly polydimethylsiloxane groups incorporated into the polymer. The present disclosure is also directed to a process for producing the polymers. The polyoxymethylene and siloxane copolymers made in accordance with the present disclosure can be used alone or in conjunction with other thermoplastic polymers. The polyoxymethylene and siloxane block copolymers can be constructed to have various different desired properties. The copolymers, for instance, can be formulated so as to have a relatively high molecular weight. Even at high molecular weights, the polymers may exhibit excellent elongation properties. For instance, copolymers made according to the present disclosure may have significantly improved elongation at yield and impact strength resistance in relation to similar polyoxymethylene polymers not containing siloxane groups.

In addition to having excellent elongation properties, the copolymers of the present disclosure can also be constructed so as to have excellent slip wear properties. In particular, the polymers can exhibit a relatively low coefficient of friction. In addition, the copolymers can exhibit wear resistance. In particular, the polymers are well suited for applications in which a polymer article made from the copolymer is continuously or periodically in sliding contact with an adjacent surface or adjacent object. For example, polymer articles made from the copolymer are well suited for use in tribological applications wherein the articles are formed into gear wheels, pulleys, sliding elements, and the like.

In one embodiment, the polyoxymethylene-polydimethylsiloxane block copolymer made in accordance with the present disclosure can have the following formula:

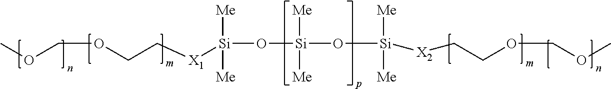

In the above formula, n is generally greater than about 5, such as greater than about 20, such as greater than about 50, such as greater than about 70, such as greater than about 100, such as greater than about 150, such as greater than about 200, such as greater than about 250, such as greater than about 300, such as greater than about 350, such as greater than about 400, such as greater than about 450, such as greater than about 500, such as greater than about 550, such as greater than about 600, such as greater than about 650, such as greater than about 700. In the above formula, n is generally less than about 1500, such as less than about 1300, such as less than about 1100, such as less than about 900. “Me” as used herein refers to a methyl group.

In the above formula, m is generally greater than about 2, such as greater than about 3, such as greater than about 4 and generally less than about 10, such as less than about 8, such as less than about 6. In the above formula, p can generally be greater than about 5, such as greater than about 10, such as greater than about 15, such as greater than about 20, such as greater than about 25, such as greater than about 30, such as greater than about 35, such as greater than about 40, such as greater than about 45, such as greater than about 50 and is generally less than about 500, such as less than about 450, such as less than about 400, such as less than about 350, such as less than about 300, such as less than about 250, such as less than about 200, such as less than about 150, such as less than about 100, such as less than about 80.

In the above formula, X₁ and X₂ can be as follows:

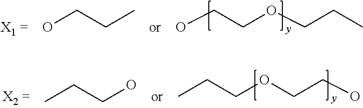

In the above formulas, y is generally greater than about 5, such as greater than about 10, such as greater than about 15, such as greater than about 20, such as greater than about 25, such as greater than about 30, such as greater than about 35 and is generally less than about 50, such as less than about 45, such as less than about 40, such as less than about 35.

In an alternative embodiment, the polyoxymethylene-polydimethylsiloxane block copolymer may have the following formula:

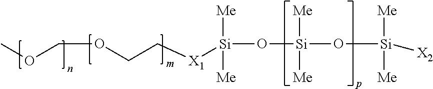

In the above formula, n, m, p, X₁, X₂, and y can have the same values as described above.

As described above, the above block copolymers containing polydimethylsiloxane groups can be constructed so as to have one or more Improved properties over a similar polyoxymethylene polymer not containing the polydimethylsiloxane groups. The polyoxymethylene-polydimethylsiloxane block copolymers as shown above can be made using various different processes. In one embodiment, a polydimethylsiloxane monomer can be used that is soluble in the polyoxymethylene polymer monomers, such as trioxane and dioxolane. For example, the polydimethylsiloxane monomer may include carbinol groups or ethylene oxide groups that have been found to render the monomer soluble in trioxane. In this manner, the monomers can form a homogeneous solution or polymerization composition that Increases the efficiency of the process and, in one embodiment, is believed to incorporate greater amounts of the polydimethylsiloxane into the polymer backbone.

For example, in one embodiment, the polydimethylsiloxane monomer comprises a polydimethylsiloxane-formal. In one embodiment, for instance, the polydimethylsiloxane monomer may include polyethylene oxide groups and may comprise polyethylene oxide-b-dimethylsiloxane-polyethylene oxide.

For example, in one embodiment, the polydimethylsiloxane monomer has the following formula:

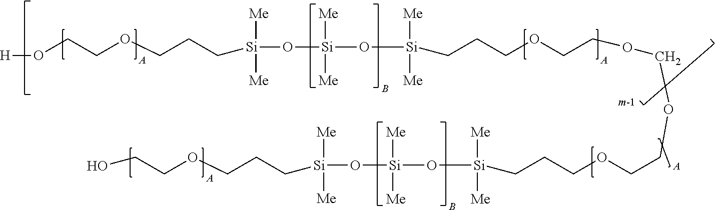

In the above formula, A can generally be greater than about 2, such as greater than about 10, such as greater than about 15, such as greater than about 20 and is generally less than about 50, such as less than about 40, such as less than about 35. B is generally greater than about 5, such as greater than about 7, such as greater than about 10, such as greater than about 15, such as greater than about 20 and generally less than about 500, such as less than about 400, such as less than about 300, such as less than about 200, such as less than about 100, such as less than about 75. In the above formula, m is greater than about 2, such as greater than about 3, such as greater than about 4 and generally less than about 10, such as less than about 8, such as less than about 7.

In order to make the above monomer, a polydimethylsiloxane having ethylene oxide groups can be used as the starting material. For instance, the starting siloxane may have the following structure:

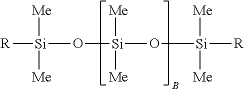

wherein the R group can be as follows:

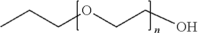

wherein B is from about 5 to about 500, such as from about 10 to about 50 and
wherein n is from about 1 to about 50, such as from about 5 to about 20.

In order to convert the above polydimethylsiloxane into the polydimethylsiloxane with ethylene oxide groups as shown above, the starting siloxane can be combined with a formaldehyde source and contacted with an ion exchange resin in the presence of a solvent, such as toluene.

In an alternative embodiment, the polydimethylsiloxane monomer can have the following formula:

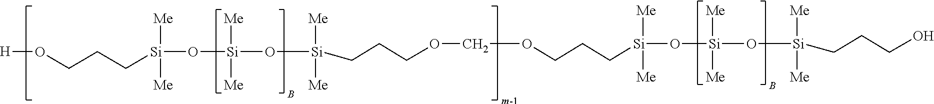

In the above formula, B is generally greater than about 5, such as greater than about 7, such as greater than about 10, such as greater than about 15, such as greater than about 20 and generally less than about 500, such as less than about 400, such as less than about 300, such as less than about 200, such as less than about 150, such as less than about 100, such as less than about 75. In the above formula, m is generally greater than about 2, such as greater than about 3, such as greater than about 4 and generally less than about 10, such as less than about 8, such as less than about 7.

As shown above, instead of ethylene oxide units, the above monomer contains carbinol units. The above monomer can be made using the following starting material:

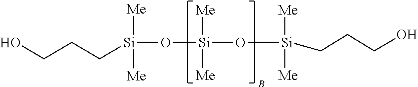

The starting material can be converted Into the monomer above by contacting the starting material with a formaldehyde source in the presence of an Ion exchange resin.

It should be understood that the block copolymers of the present disclosure do not necessarily have to be constructed from the above monomers. In other embodiments, for instance, unmodified polydimethylsiloxane monomers may be used to produce the block copolymers.

One or more polydimethylsiloxane monomers are combined with a polyoxymethylene monomer and optionally a third monomer to produce the polyoxymethylene-polydimethylsiloxane block copolymers. The polyoxymethylene monomer generally comprises a monomer that forms —CH₂—O— units. For instance, the polyoxymethylene monomer may comprise a cyclic acetal such as trioxane, tetraoxane, or mixtures thereof.

In one embodiment, a third monomer may be present that can form repeat units of a saturated or ethylenically unsaturated alkylene group having at least two carbon atoms or a cycloalkylene group. The monomer content of the third monomer can be greater than about 0% and up to about 50 mol %. For instance, the third monomer can be added so as to produce from about 0.01 mol % to about 20 mol %, such as from about 0.5 mol % to about 10 mol %, such as from about 1 mol % to about 5 mol % of the above repeat units. The third monomer, for Instance, may comprise a cyclic ether or acetal having the following formula:

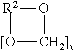

in which x is 0 or 1 and R² is a C₂-C₄-alkylene group which, if appropriate, has one or more substituents which are C₁-C₄-alkyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers.

As described above, in one embodiment, the polydimethylsiloxane monomer may be soluble in the other monomers for producing a homogeneous reaction. Alternatively, a heterogeneous process may occur.

Polymerization can generally occur at temperatures from about 40° C. to about 150° C. The polymerization can take place at pressures of from about 1 to about 100 bar, such as from about 1 to about 40 bar.

During polymerization, the monomers are combined together and contacted with a catalyst.

The catalyst is typically an acidic species capable of initiating a reaction. For instance, in one embodiment, the catalyst may comprise a sulfur-containing acid. In an alternative embodiment, a heterogeneous catalyst, such as a solid catalyst may be used. As used herein, a solid catalyst is a catalyst that includes one solid component. For instance, a catalyst may comprise an acid that is adsorbed or otherwise fixed to a solid support. The catalyst may also be in a liquid phase that is not miscible or at least partially immiscible with the reaction mixture.

The catalyst can be selected from the group consisting of trifluoromethanesulfonic acid, perchloric acid, methanesulfonic acid, toluenesulfonic acid and sulfuric acid, or derivatives thereof such as anhydrides or esters or any other derivatives that generate the corresponding acid under the reaction conditions. Lewis acids like boron trifluoride, arsenic pentafluoride can also be used. It is also possible to use mixtures of all the individual catalysts mentioned above.

In one embodiment, the catalyst may comprise a Lewis or Broensted acid species dissolved in an inorganic molten salt. The molten salt may have a melting point below 200° C., such as less than about 100° C., such as less than about 30° C. The molten salt can then be immobilized or fixed onto a solid support as described above. The solid support, for instance, may be a polymer or a solid oxide. An example of an organic molten salt include ionic liquids. For instance, the ionic liquid may comprise 1-n-alkyl-3-methylimidazolium triflate. Another example is 1-n-alkyl-3-methylimidazolium chloride.

In one embodiment, the acidic compound present in the catalyst can have a pKa below 0, such as below about −1, such as below about −2, when measured in water at a temperature of 18° C. The pKa number expresses the strength of an acid and is related to the dissociation constant for the acid in an aqueous solution.

Examples of heterogeneous catalysts that may be used according to the present disclosure include the following:

(1) solid catalysts represented by acidic metal oxide combinations which can be supported onto usual carrier materials such as silica, carbon, silica-alumina combinations or alumina. These metal oxide combinations can be used as such or with inorganic or organic acid doping. Suitable examples of this class of catalysts are amorphous silica-alumina, acid clays, such as smectites, inorganic or organic acid treated clays, pillared clays, zeolites, usually in their protonic form, and metal oxides such as ZrO2-TIO2 in about 1:1 molar combination and sulfated metal oxides e.g. sulfated ZrO2. Other suitable examples of metal oxide combinations, expressed in molar ratios, are: TiO2-SiO2 1:1 ratio; and ZrO2-SiO2 1:1 ratio.

(2) several types of cation exchange resins can be used as acid catalyst to carry out the reaction. Most commonly, such resins comprise copolymers of styrene, ethylvinyl benzene and divinyl benzene functionalized so as to graft SO3H groups onto the aromatic groups. These acidic resins can be used in different physical configurations such as in gel form, in a macro-reticulated configuration or supported onto a carrier material such as silica or carbon or carbon nanotubes. Other types of resins include perfluorinated resins carrying carboxylic or sulfonic acid groups or both carboxylic and sulfonic acid groups. Known examples of such resins are: NAFION, and AMBERLYST resins. The fluorinated resins can be used as such or supported onto an inert material like silica or carbon or carbon nanotubes entrapped in a highly dispersed network of metal oxides and/or silica.

(3) heterogeneous solids, having usually a lone pair of electrons, like silica, silica-alumina combinations, alumina, zeolites, silica, activated charcoal, sand and/or silica gel can be used as support for a Broensted acid catalyst, like methane sulfonic acid or para-toluene sulfonic acid, or for a compound having a Lewis acid site, such as SbF5, to thus interact and yield strong Broensted acidity. Heterogeneous solids, like zeolites, silica, or mesoporous silica or polymers like e.g. polysiloxanes can be functionalized by chemical grafting with a Broensted acid group or a precursor therefore to thus yield acidic groups like sulfonic and/or carboxylic acids or precursors therefore. The functionalization can be introduced in various ways known in the art like: direct grafting on the solid by e.g. reaction of the SiOH groups of the silica with chlorosulfonic acid; or can be attached to the solid by means of organic spacers which can be e.g. a perfluoro alkyl silane derivative. Broensted acid functionalized silica can also be prepared via a sol gel process, leading to e.g. a thiol functionalized silica, by co-condensation of Si(OR)4 and e.g. 3-mercaptopropyl-tri-methoxy silane using either neutral or ionic templating methods with subsequent oxidation of the thiol to the corresponding sulfonic acid by e.g. H2O2. The functionalized solids can be used as is, i.e. in powder form, in the form of a zeolitic membrane, or in many other ways like in admixture with other polymers in membranes or in the form of solid extrudates or in a coating of e.g. a structural inorganic support e.g. monoliths of cordierite; and

(4) heterogeneous heteropolyacids having most commonly the formula HxPMyOz. In this formula, P stands for a central atom, typically silicon or phosphorus. Peripheral atoms surround the central atom generally in a symmetrical manner. The most common peripheral elements, M, are usually Mo or W although V, Nb, and Ta are also suitable for that purpose. The indices xyz quantify, in a known manner, the atomic proportions in the molecule and can be determined routinely. These polyacids are found, as is well known, in many crystal forms but the most common crystal form for the heterogeneous species is called the Keggin structure. Such heteropolyacids exhibit high thermal stability and are non-corrosive. The heterogeneous heteropolyacids are preferably used on supports selected from silica gel, kieselguhr, carbon, carbon nanotubes and ion-exchange resins. A preferred heterogeneous heteropolyacid herein can be represented by the formula H3PM12040 wherein M stands for W and/or Mo. Examples of preferred PM moieties can be represented by PW12, PMo12, PW12/SiO2, PW12/carbon and SMW12.

In order to terminate the polymerization, the reaction mixture, which still comprises unconverted monomers, such as trioxane, alongside polymer, is brought into contact with deactivators. These can be added in bulk form or a form diluted with an inert aprotic solvent to the polymerization mixture. The result is rapid and complete deactivation of the active chain ends.

Deactivators that can be used are those compounds which react with the active chain ends in such a way as to terminate the polymerization reaction. Examples are the organic bases triethylamine or melamine, and also the inorganic bases potassium carbonate or sodium acetate. It is also possible to use very weak organic bases, such as carboxamides, e.g. dimethylformamide. Tertiary bases are particularly preferred, examples being triethylamine and hexamethylmelamine.

The concentrations used of the bases are from 1 ppm to 1% by weight, based on the polymerization material. Concentrations of from 10 ppm to 5000 ppm are preferred.

Typical deactivation temperatures vary in the range from 125° C. to 180° C., particularly preferably in the range from 135° C. to 160° C., and very particularly preferably in the range from 140° C. to 150° C.

Typical deactivation pressures vary in the range from 1 to 100 bar, preferably from 1 to 40 bar.

The polymerization can take place in reactors known for the preparation of POM homo- and copolymers. The polymerization can also take place in a batch-wise manner. Typically, kneaders or extruders are used, designed to be temperature-controllable and pressure-resistant.

After deactivation of the block copolymer, the polymer can be brought to an elevated temperature to remove unstable end groups if desired. The liquid polymerization mixture can be transferred into a depressurization zone and residual monomers and solvent can be removed via application of a reduced pressure.

The polyoxymethylene-polydimethylsiloxane block copolymer of the present disclosure can generally have any suitable molecular weight. The molecular weight of the polymer, for instance, can be from about 10 g/mol to about 20,000 g/mol. For instance, the molecular weight can be from about 20 g/mol to about 10,000 g/mol, such as from about 20 g/mol to about 8,000 g/mol.

The polyoxymethylene-polydimethylsiloxane block copolymer can generally have a melt flow index ranging from about 0.1 g/10 min to about 150 g/10 min, as determined according to ISO Test 1133 at 190° C. and at a load of 2.16 kg. For instance, the melt flow index can be relatively high, such as greater than about 50 g/10 min, such as greater than about 70 g/10 min, such as greater than about 90 g/10 min, and generally less than about 300 g/10 min, such as less than about 200 g/10 min. In other embodiments, it is believed that lower melt flow indexes are possible. For instance, in other embodiments, the melt flow Index can be less than about 50 g/10 min, such as less than about 30 g/10 min, such as less than about 10 g/10 min.

Once the block copolymer has been formed, the polymer can be formed with various different additives including antioxidants, acid scavengers, formaldehyde scavengers, UV stabilizers, heat stabilizers, processing aids, lubricants, nucleating agents, fillers, and the like.

For example, in one embodiment, a formaldehyde scavenger may be combined with the polymer. A formaldehyde scavenger is a compound that reacts and binds formaldehyde.

In general, the total amount of formaldehyde scavengers present in the composition is relatively small. For instance, the formaldehyde scavengers can be present in an amount less than about 2 percent by weight, such as from about 0.01 percent to about 2 percent by weight, such as from about 0.05 percent to about 0.5 percent by weight (which excludes other nitrogen containing compounds that may be present in the composition that are not considered formaldehyde scavengers such as waxes or hindered amines). Any suitable formaldehyde scavenger can be included into the composition including, for example, aminotriazine compounds, allantoin, hydrazides, polyamides, melamines, or mixtures thereof. In one embodiment, the nitrogen containing compound may comprise a heterocyclic compound having at least one nitrogen atom adjacent to an amino substituted carbon atom or a carbonyl group. In one specific embodiment, for instance, the nitrogen containing compound may comprise benzoguanamine.

In still other embodiments, the nitrogen containing compound may comprise a melamine modified phenol, a polyphenol, an amino acid, a nitrogen containing phosphorus compound, an acetoacetamide compound, a pyrazole compound, a triazole compound, a hemiacetal compound, other guanamines, a hydantoin, a urea including urea derivatives, and the like.

The nitrogen containing compound may comprise a low molecular weight compound or a high molecular weight compound. The nitrogen-containing compound having a low molecular weight may include, for example, an aliphatic amine (e.g., monoethanolamine, diethanolamine, and tris-(hydroxymethyl)aminomethane), an aromatic amine (e.g., an aromatic secondary or tertiary amine such as o-toluidine, p-toluidine, p-phenylenediamine, o-aminobenzoic acid, p-aminobenzoic acid, ethyl o-aminobenzoate, or ethyl p-aminobenzoate), an imide compound (e.g., phthalimide, trimellitimide, and pyromellitimide), a triazole compound (e.g., benzotriazole), a tetrazole compound (e.g., an amine salt of 5,5′-bitetrazole, or a metal salt thereof), an amide compound (e.g., a polycarboxylic acid amide such as malonamide or isophthaldiamide, and p-aminobenzamide), hydrazine or a derivative thereof [e.g., an aliphatic carboxylic acid hydrazide such as hydrazine, hydrazone, a carboxylic acid hydrazide (stearic hydrazide, 12-hydroxystearic hydrazide, adipic dihydrazide, sebacic dihydrazide, or dodecane diacid dihydrazide; and an aromatic carboxylic acid hydrazide such as benzoic hydrazide, naphthoic hydrazide, isophthalic dihydrazide, terephthalic dihydrazide, naphthalenedicarboxylic dihydrazide, or benzenetricarboxylic trihydrazide)], a polyaminotriazine [e.g., guanamine or a derivative thereof, such as guanamine, acetoguanamine, benzoguanamine, succinoguanamine, adipoguanamine, 1,3,6-tris(3,5-diamino-2,4,6-triazinyl)hexane, phthaloguanamine or CTU-guanamine, melamine or a derivative thereof (e.g., melamine, and a condensate of melamine, such as melam, melem or melon)], a salt of a polyaminotriazine compound containing melamine and a melamine derivative with an organic acid [for example, a salt with (iso)cyanuric acid (e.g., melamine cyanurate)], a salt of a polyaminotriazine compound containing melamine and a melamine derivative with an inorganic acid [e.g., a salt with boric acid such as melamine borate, and a salt with phosphoric acid such as melamine phosphate], uracil or a derivative thereof (e.g., uracil, and uridine), cytosine and a derivative thereof (e.g., cytosine, and cytidine), guanidine or a derivative thereof (e.g., a non-cyclic guanidine such as guanidine or cyanoguanidine; and a cyclic guanidine such as creatinine), urea or a derivative thereof [e.g., biuret, biurea, ethylene urea, propylene urea, acetylene urea, a derivative of acetylene urea (e.g., an alkyl-substituted compound, an aryl-substituted compound, an aralkyl-substituted compound, an acyl-substituted compound, a hydroxymethyl-substituted compound, and an alkoxymethyl-substituted compound), isobutylidene diurea, crotylidene diurea, a condensate of urea with formaldehyde, hydantoin, a substituted hydantoin derivative (for example, a mono or diC₁₋₄alkyl-substituted compound such as 1-methylhydantoin, 5-propylhydantoin or 5,5-dimethylhydantoin; an aryl-substituted compound such as 5-phenylhydantoin or 5,5-diphenylhydantoin; and an alkylaryl-substituted compound such as 5-methyl-5-phenylhydantoin), allantoin, a substituted allantoin derivative (e.g., a mono, di or triC₁₋₄alkyl-substituted compound, and an aryl-substituted compound), a metal salt of allantoin (e.g., a salt of allantoin with a metal element of the Group 3B of the Periodic Table of Elements, such as allantoin dihydroxyaluminum, allantoin monohydroxyaluminum or allantoin aluminum), a reaction product of allantoin with an aldehyde compound (e.g., an adduct of allantoin and formaldehyde), a compound of allantoin with an imidazole compound (e.g., allantoin sodium dl-pyrrolidonecarboxylate), an organic acid salt].

The composition may also contain colorants, light stabilizers, antioxidants, heat stabilizers, processing aids, and fillers.

Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 2 percent by weight.

In one embodiment, the composition may contain a nucleant. The nucleant, for instance, may increase crystallinity and may comprise an oxymethylene terpolymer. In one particular embodiment, for instance, the nucelant may comprise a terpolymer of butanediol diglycidyl ether, ethylene oxide or dioxolane, and trioxane. The nucleant can be present in the composition in an amount greater than about 0.05% by weight, such as greater than about 0.1% by weight. The nucleant may also be present in the composition in an amount less than about 2% by weight, such as in an amount less than about 1% by weight.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate] (Irganox 259, BASF), and 3,5-di-tert-butyl-4-hydroxytoluene (Lowinox BHT, Chemtura). Preference is given to Irganox 1010 and especially Irganox 245. The above compounds may be present in the composition in an amount less than about 2% by weight, such as in an amount from about 0.01% to about 1% by weight.

Light stabilizers that may be present in the composition Include sterically hindered amines. Such compounds include 2,2,6,6-tetramethyl-4-piperidyl compounds, e.g., bis(2,2,6,6-tetramethyl-4-piperidyl) sebacate (Tinuvin 770, BASF) or the polymer of dimethyl succinate and 1-(2-hydroxyethyl)-4-hydroxy-2,2,6,6-tetramethyl-4-pipendine (Tinuvin 622, BASF). In one embodiment, the light stabilizer may comprise 2-(2H-benzzotriazol-2-yl) 4,6-bis(1-ethyl-1-phenyl-ethyl)phenol (Tinuvin 234). Other hindered amine light stabilizers that may be used include oligomeric compounds that are N-methylated. For instance, another example of a hindered amine light stabilizer comprises ADK STAB LA-63 light stabilizer available from Adeka Palmarole.

One or more light stabilizers may be present in the composition in an amount generally less than about 5% by weight, such as in an amount less than 4% by weight, such as in an amount less than about 2% by weight. The light stabilizers, when present, can be included in amounts greater than about 0.1% by weight, such as in amounts greater than about 0.5% by weight.

The above light stabilizers may protect the composition from ultraviolet light. In addition to the above light stabilizers, UV stabilizers or absorbers that may also be present in the composition Include benzophenones or benzotriazoles.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm. The composition can further include thermoplastic or thermoset polymeric additives, or elastomers such as polyethylene, polyurethane, polymethyl methacrylate, polybutadiene, polystyrene, or else graft copolymers whose core has been prepared by polymerizing 1,3-butadiene, isoprene, n-butyl acrylate, ethylhexyl acrylate, or mixtures of these, and whose shell has been prepared by polymerizing styrene, acrylonitrile or (meth)acrylates.

Various different polymer articles can be formed from the block copolymer(s) of the present disclosure.

Shaping processes for forming articles of the composition can include, without limitation, extrusion, injection molding, blow-molding, compression molding, hot-stamping, pultrusion, and so forth. Shaped articles that may be formed may include structural and non-structural shaped parts. For instance, automotive components such as fuel tanks, and fuel caps, fuel filler necks, fuel sender unit components (e.g. flanges or swirl pot), fuel pumps, fuel rails, turn signal and light shifters, power window components, door lock system components, and so forth can be formed from the polyoxymethylene composition.

The block copolymer can be shaped according to an injection molding process to form products that can have a relatively intricate or complicated shape. For example, products that can be formed from the block copolymer composition that may be formed according to an injection molding process can include components such as, without limitation, mechanical gears, sliding and guiding elements, housing parts, springs, chains, screws, nuts, fan wheels, pump parts, valve bodies, hardware such as locks, handles, and hinges, zippers, and so forth.

The block copolymer can also be utilized in electrical applications, for instance in forming insulators, bobbins, connectors, and parts for electronic devices such as televisions, telephones, etc. Medical devices such as injection pens and metered dose inhalers can be formed of the polyoxymethylene composition as well as a variety of sporting goods equipment (e.g., paintball accessories and airsoft guns) and household appliances (e.g., coffee makers and knife handles).

The present disclosure may be better understood with reference to the following examples.

### Example No. 1

In this example, non-modified polydimethylsiloxane monomers were converted into polydimethylsiloxane-formals. The polydimethylsiloxane-formals are well suited for constructing copolymers in accordance with the present disclosure.

The unmodified polydimethylsiloxane monomers had the following general formula:

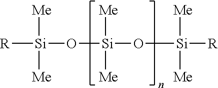

The particular polydimethyislloxane monomer used in this experiment were as follows. Also in the table below are the other solvents, catalysts and formaldehyde source used.

| | PDMS | | m PDMS | n PDMS | m HFO | n HFO | V Toluol | Amberlyst 15 |
|---|---|---|---|---|---|---|---|---|
| Sample | End Group R | n | [g] | [mol] | [g] | [mol] | [ml] | [g] |
| 1 | 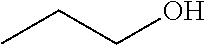 | 15 | 50.0 | 0.05 | 24.1 | 0.8 | 50.0 | 20.0 |
| 2 | 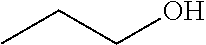 | 50 | 50.0 | 0.01 | 8.0 | 0.3 | 50.0 | 20.0 |
| 3 | 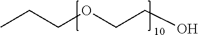 | 15 | 50.0 | 0.03 | 13.4 | 0.5 | 50.0 | 20.0 |

PDMS = Polyclimethylsiloxane
HFO = Paraformaidehyde

### General Procedure Ion Exchange Preparation:

The ion exchange resin had to be conditioned. In a first step 20 g of the wet resin was stirred in 50 ml acetone for 10 minutes and subsequently the solvent was decanted. Then the resin was filtered and washed with 30 mol toluene. It should be ensured that the resin doesn't dry.

### Exemplary Synthesis for Sample 1

### Equation for Samples 1 and 2

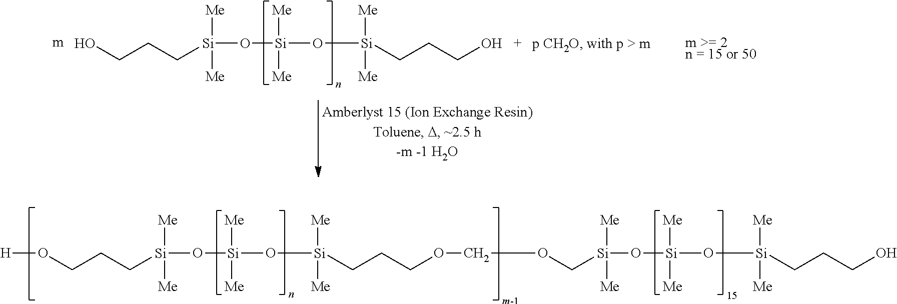

50.0 g of the Polydimethylsiloxane were dissolved together with 24.1 g paraformaldehyde and 20 g ion exchange resin in 50 ml toluene and stirred under reflux. The formed water was collected in a water separator (Dean-Stark apparatus). Since the paraformaldehyde was not dried before usage the formed water amounts was larger than the theoretical calculated. The reaction was terminated when no further water formation was observed. Then the mixture was filtered at ˜70° C. to remove the resin. Finally the filtrate was evaporated to remove the toluene and remaining paraformaldehyde. Since the reaction was driven to high conversions 295%, a subsequent purification was not done.

### Exemplary Synthesis for Sample 2

The same procedure as in example 1 was performed. Now, using 50.0 g of the Polydimethylsiloxane having a longer Siloxane chain (n=50) and 8.0 g of paraformaldehyde and 20 g ion exchange resin. This has been dissolved in 50 ml toluene and stirred under reflux.

### Exemplary Synthesis for Sample 3

### Equation for Sample 3

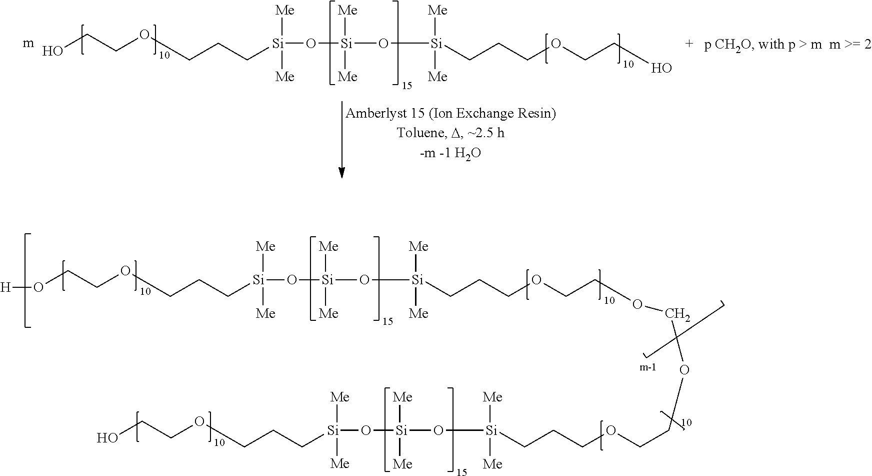

According to the procedure in example 1, 50.0 g of a Polydimethylsiloxanes (PDMS) having ethylenoxide groups in alpha-omega position was used and reacted with 13.4 g paraformaldehyde in the presence of 20 g ion exchange resin in 50 ml toluene.

TABLE 1
Results PDMS-Formals.

| | | | | | Factor | | Viscosity @ |
|---|---|---|---|---|---|---|---|
| | PDMS | | Conversion* | Purity* | Chain | M_{n, Formal} | 65° C. |
| Sample | End Group R | n | [%] | [%] | Extension | [g/mol] | [Pa s] |
| 1 | 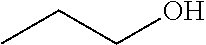 | 15 | ≥95 | ≥95 | 2 | 1.843 | 0.02 |
| 2 | 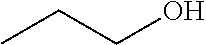 | 50 | ≥95 | ≥95 | 2 | 7.060 | 191.89 |
| 3 | 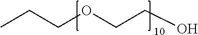 | 15 | ≥95 | ≥95 | 4 | 7.836 | 0.22 |

*Determined by 1H-NMR and IR Spectroscopie

The testing of the produced PDMS-Formals was performed according to the following standards:

Conversions and purities were determined by NMR using d-HFIP on a Varian 400 MHz-Spectrometer and a Bruker 400 MHz-Spectrometer Conversions and purities were determined by Infrared Spectroscopy on a Bruker Tensor 27 according DIN 51451.
GPC measurements were done on a SunChrom Sun Flow 100 device using hexafluoroisopropanol as eluent and two PSS-PFG columns (8×300 mm, 100 Å+1000 Å), detector Agilent 1200 RI-detector.
Rheologie measurements were done on ARES G2, shear rates 0.01-200 1/s, T=65° C., t=300 s, geometry 50 mm cone plate, 0.04 rad, stainless steel

### Example No. 2

In this example, polydimethylsiloxane-formal monomers made according to Example 1 were polymerized with trioxane and dioxolane in order to form polyoxymethylene-polydimethylsiloxane block copolymers in accordance with the present disclosure.

Trioxane was polymerized with 3.4 w.-% of Dioxolane and a Polydimethylsiloxaneformal (PDMS-Formal) at temperatures between 75° C. and 100° C. using a specified amount of trifluoromethanesulfonic acid. The PDMS-Formals used either had bis-carbinol or bis-ethylenoxide end-groups, whereas the bis-ethylenoxide substituted PDMS systems are soluble in trioxane and dioxolane and therefore allow a homogenous polymerization already under above described conditions. Typically the polymerization starts after a short induction period between 5 and 72 seconds. After 5 minutes the obtained raw material was grinded and hydrolyzed at 170° C. in 1 liter of n-Methyl-2-pyrrolidon (NMP) to which has been added 1 ml of Triethylamine (TEA). After one hour the system was allowed to cool down to room temperature again whereas the POM-PDMS precipitates as a very fine powder. Afterwards the product was filtered and washed three times each with 50 ml of methanol and finally dried at 60° C. and nitrogen atmosphere.

TABLE 1
Copolymerization of Trioxane, Dioxolane and PDMS-Formals

| | | | | | PDMS- | | | Incorporated |
|---|---|---|---|---|---|---|---|---|
| | PDMS- | PDMS | trioxane | dioxolane | Formal | | Induction | PDMS |
| Sample | Formal | End Group | [w. %] | [w. %] | [w. %] | T [° C.] | Period [s] | [w. %] |
| 4 | Sample #1 | Carbinol | 86.6 | 3.4 | 10.0 | 75 | 7 | 9.4 |
| 5 | Sample #2 | Carbinol | 86.6 | 3.4 | 10.0 | 75 | 5 | 8.9 |
| 6 | Sample #3 | Ethylenoxide | 96.1 | 3.4 | 0.5 | 100 | 10 | 0.47 |
| 7 | Sample #3 | Ethylenoxide | 95.6 | 3.4 | 1.0 | 100 | 30 | 0.98 |
| 8 | Sample #3 | Ethylenoxide | 91.6 | 3.4 | 5.0 | 100 | 72 | 4.85 |
| | | | | Melting | Enthalpie 2. | | | |
| | M_{w} | Mₙ | | Point | Heating | Crystallinity | Onset | Crystallization |
| Sample | [g/mol] | [g/mol] | PD | [° C.] | [J/g] | [%] | [° C.] | Point [° C.] |
| 4 | 25.846 | 7.684 | 3.4 | 160.3 | 153.4 | 46.9 | 141.2 | 138.0 |
| 5 | 45.756 | 13.637 | 3.4 | 155.9 | 155.2 | 47.5 | 143.8 | 137.7 |
| 6 | 30.456 | 9.763 | 3.1 | 163.7 | 166.0 | 50.9 | 145.4 | 142.6 |
| 7 | 52.237 | 9.137 | 5.7 | 163.4 | 163.6 | 50.2 | 145.4 | 142.7 |
| 8 | 23.415 | 7.753 | 3.0 | 162.1 | 158.8 | 48.7 | 145.6 | 142.4 |

| | Particle Sizes | | |
|---|---|---|---|
| | POM-PDMS Powder (μm) | | |
| Sample | d10 | d50 | d90 |
| 4 | 52.9 | 79.4 | 108.8 |
| 5 | 57.0 | 116.1 | 387.1 |
| 6 | 74.2 | 113.7 | 157.9 |
| 7 | 72.9 | 121.2 | 173.2 |
| 8 | 62.7 | 95.5 | 127.8 |
| Polyoxymethylene | 121.4 | 424.2 | 987.8 |
| polymer having a | | | |
| MFI of 9 g/10 min | | | |
| for reference | | | |

As shown above, a polyoxymethylene polymer made according to substantially the same procedure without the use of a siloxane monomer produces much larger particle sizes.

The testing of the produced polymers was performed according to the following standards:

NMR measurements were performed in d-HFiP on a Varian 400 MHz-Spectrometer and a Bruker 400 MHz-Spectrometer
Incorporation rates were determined by evaporation of the NMP and the methanol and following mass balance.
Thermal data (melting point, onset and crystallization point) have been determined with Differential Scanning Calorimetry (DSC, TA Instruments, Q200); heating rate 10K/min. according to ISO 11357-1, -2, -3.
GPC measurements were done on a SunChrom Sun Flow 100 device using hexafluoroisopropanol as eluent and two PSS-PFG columns (8×300 mm, 100 Å+1000 Å), detector Agilent 1200 RI-detector.
Particle Sizes were determined on a Beckman Coulter LS 13 320.

### Example No. 3

In this example, non-modified polydimethylsiloxane monomers were used to produce the block copolymers.

Trioxane was polymerized with 3.4 w.-% of Dioxolane and a Polydimethylsiloxane (PDMS) at temperatures between 75° C. and 110° C. using a specified amount of trifluoromethanesulfonic acid. The Polydimethylsiloxanes used either had bis-carbinol or bis-ethylenoxide end-groups (see formula and first table in Example No. 1), whereas the bis-ethylenoxide substituted PDMS systems are soluble in trioxane and dioxolane and therefore allow a homogenous polymerization already under above described conditions. Typically the polymerization starts after a short induction period between 4 and 110 seconds. After 5 minutes the obtained raw material was grinded and hydrolyzed at 170° C. in 1 liter of n-Methyl-2-pyrrolidon (NMP) to which has been added 1 ml of Triethylamine (TEA). After one hour the system was allowed to cool down to room temperature again whereas the POM-PDMS precipitates as a very fine powder. Afterwards the product was filtered and washed three times each with 50 ml of methanol and finally dried at 60° C. and nitrogen atmosphere.

The following results were obtained:

TABLE 2
Copolymerization of Trioxane, Dioxolane and unmodified PDMS

| | | | | | | | | Incorporated |
|---|---|---|---|---|---|---|---|---|
| | | PDMS | trioxane | dioxolane | PDMS | | Induction | PDMS |
| Sample | n_{PDMS} | End Group | [w. %] | [w. %] | [w. %] | T [° C.] | Period [s] | [w. %] |
| 9 | 15 | Carbinol | 86.6 | 3.4 | 10.0 | 75 | 21 | 8.94 |
| 10 | 50 | Carbinol | 86.6 | 3.4 | 10.0 | 75 | 12 | 8.52 |
| 11 | 15 | Ethylenoxide | 96.1 | 3.4 | 0.5 | 100 | 78 | 0.48 |
| 12 | 15 | Ethylenoxide | 95.6 | 3.4 | 1.0 | 100 | 19 | 0.97 |
| 13 | 15 | Ethylenoxide | 93.6 | 3.4 | 3.0 | 100 | 20 | 2.61 |
| 14 | 15 | Ethylenoxide | 91.6 | 3.4 | 5.0 | 100 | 110 | 4.80 |
| 15 | 50 | Ethylenoxide | 95.1 | 3.4 | 1.5 | 110 | 4 | 1.47 |
| 16 | 50 | Ethylenoxide | 91.6 | 3.4 | 5.0 | 110 | 95 | 3.93 |
| | | | | Melting | Enthalpie 2. | | | |
| | M_{w} | Mₙ | | Point | Heating | Crystallinity | Onset | Crystallinization |
| Sample | [g/mol] | [g/mol] | PD | [° C.] | [J/g] | [%] | [° C.] | Point [° C.] |
| 9 | 15.620 | 7.091 | 2.2 | 162.2 | 154.2 | 47.3 | 145.4 | 142.5 |
| 10 | 23.856 | 8.135 | 2.9 | 163.1 | 150.0 | 46.0 | 147.9 | 145.3 |
| 11 | 46.613 | 10.629 | 4.4 | 163.2 | 166.3 | 51.0 | 144.9 | 143.0 |
| 12 | 54.041 | 9.253 | 5.8 | 164.0 | 167.2 | 51.3 | 145.9 | 143.8 |
| 13 | 34.135 | 10.030 | 3.4 | 163.2 | 170.1 | 52.2 | 145.9 | 142.8 |
| 14 | 26.133 | 8.735 | 3.0 | 163.3 | 163.6 | 50.2 | 145.4 | 142.4 |
| 15 | 91.109 | 21.286 | 4.3 | 165.9 | 164.4 | 50.4 | 145.6 | 143.0 |
| 16 | 46.533 | 13.309 | 3.5 | 164.5 | 148.2 | 45.7 | 145.3 | 142.2 |

| | Particle Sizes | | |
|---|---|---|---|
| | POM-PDMS Powder (μm) | | |
| Sample | d10 | d50 | d90 |
| 9 | 32.8 | 62.0 | 92.5 |
| 10 | 79.3 | 146.7 | 206.9 |
| 11 | 59.2 | 101.0 | 156.2 |
| 12 | 58.6 | 116.0 | 181.2 |
| 13 | 67.3 | 106.2 | 151.7 |
| 14 | 33.2 | 69.6 | 107.2 |
| 15 | 46.8 | 104.1 | 175.1 |
| 16 | 37.5 | 81.2 | 136.8 |
| Polyoxymethylene | 121.4 | 424.2 | 987.8 |
| polymer having a | | | |
| MFI of 9 g/10 min | | | |
| for reference | | | |

As shown above, a polyoxymethylene polymer made according to substantially the same procedure without the use of a siloxane monomer produces much larger particle sizes.

The testing of the produced polymers was performed according to the following standards:

NMR measurements were performed in d-HFIP on a Varian 400 MHz-Spectrometer and a Bruker 400 MHz-Spectrometer
Incorporation rates were determined by evaporation of the NMP and the methanol and following mass balance.
Thermal data (melting point, onset and crystallization point) have been determined with Differential Scanning Calorimetry (DSC, TA Instruments, Q200); heating rate 10K/min. according to ISO 11357-1, -2, -3.
GPC measurements were done on a SunChrom Sun Flow 100 device using hexafluoroisopropanol as eluent and two PSS-PFG columns (8×300 mm, 100 Å+1000 Å), detector Agilent 1200 RI-detector.
Particle Sizes were determined on a Beckman Coulter LS 13 320.

These and other modifications and variations to the present invention may be practiced by those of ordinary skill in the art, without departing from the spirit and scope of the present invention, which is more particularly set forth in the appended claims. In addition, it should be understood that aspects of the various embodiments may be Interchanged both in whole or in part. Furthermore, those of ordinary skill in the art will appreciate that the foregoing description is by way of example only, and is not intended to limit the invention so further described in such appended claims.

What is claimed is:

1. A polyoxymethylene-polydimethylsiloxane block copolymer comprising a polymer having the following formula: 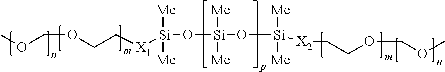
wherein n is from about 5 to about 1500, m is from 2 to 10, p is from 5 to 500, and wherein 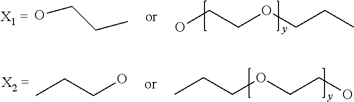
and wherein y is from about 5 to about 50;
or 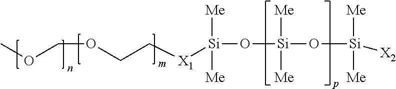
wherein n is from about 5 to about 1500, m is from 2 to 10, p is from 5 to 500, and wherein 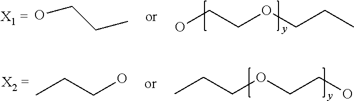
and wherein y is from about 5 to about 50.

2. A polyoxymethylene-polydimethylsiloxane block copolymer as defined in claim 1, wherein the polymer has the following formula: 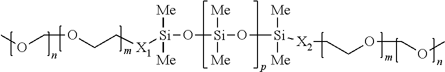
wherein n is from about 5 to about 1500, m is from 2 to 10, p is from 5 to 500, and wherein 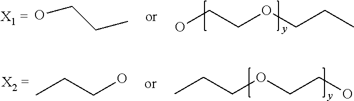
and wherein y is from about 5 to about 50.

3. A polyoxymethylene-polydimethylsiloxane block copolymer as defined in claim 1, wherein the polymer has the following formula: 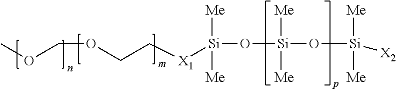
wherein n is from about 5 to about 1500, m is from 2 to 10, p is from 5 to 500, and wherein 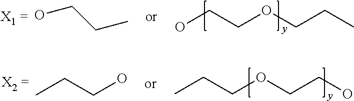
and wherein y is from about 5 to about 50.

4. A polyoxymethylene-polydimethylsiloxane block copolymer as defined in claim 1, wherein the block copolymer is formed having a d50 particle size of less than about 350 microns, and generally greater than about 20 microns.

5. A polyoxymethylene-polydimethylsiloxane block copolymer as defined in claim 1, wherein the copolymer contains polydimethylsiloxane units in an amount from about 0.5% to about 10% by weight.

6. A polyoxymethylene-polydimethylsiloxane block copolymer as defined in claim 1, wherein p is from 5 to 80.

7. A polyoxymethylene-polydimethylsiloxane block copolymer as defined in claim 1, wherein the copolymer contains dioxolane units in an amount greater than 0 mol % and up to about 50 mol %.

8. A process for producing a polyoxymethylene and siloxane block copolymer comprising:
combining a first monomer that forms —CH₂—O— units with a second monomer comprising a siloxane including carbinol groups or ethylene oxide groups; and
polymerizing the first monomer with the second monomer to form a polyoxymethylene-siloxane block copolymer.

9. A process as defined in claim 8, wherein the second monomer is soluble in the first monomer.

10. A process as defined in claim 8, wherein the second monomer comprises a polyethylene oxide-b-dimethylsiloxane-polyethylene oxide.

11. A process as defined in claim 8, wherein the second monomer has the following formula: 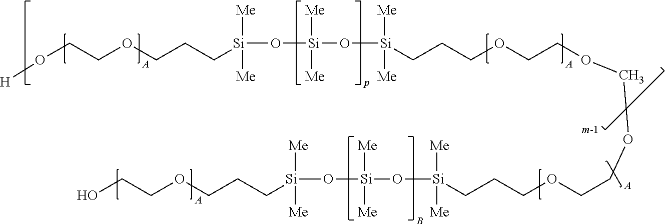
and wherein A is from about 2 to about 50; B is from about 5 to about 500; and m is from about 2 to about 10.

12. A process as defined in claim 8, wherein the second monomer has the following formula: 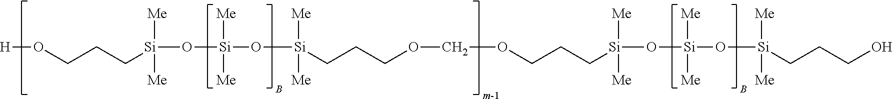
and wherein B is from about 5 to about 500; and m Is from about 2 to 5 about 10.

13. A process as defined in claim 8, wherein the first monomer comprises trioxane, tetraoxane, or mixtures thereof.

14. A process as defined in claim 8, wherein the first monomer and the second monomer are further combined with a third monomer, the third monomer comprising dioxolane.

15. A process as defined in claim 8, wherein the polyoxymethylene-siloxane block copolymer comprises a polyoxymethylene-polydimethylsiloxane block copolymer.

16. A process as defined in claim 8, wherein the polyoxymethylene-siloxane block copolymer comprises a polyoxymethylene-polydimethylsiloxane-polyoxymethylene triblock copolymer.

17. A process as defined in claim 8, wherein the second monomer forms siloxane middle groups on the block copolymer.

18. A process as defined in claim 8, further comprising the step of adding a deactivator to deactivate the polymerization.

19. A process as defined in claim 17, wherein the formed block copolymer comprises a polymer melt when the deactivator is added.

20. A process as defined in claim 8, wherein the polymerization occurs in the presence of trifluoromethansulfonic acid or derivative thereof or a heteropoly acid or boron trifluoride or derivative thereof

21. A process as defined in claim 8, wherein the polymer contacts an ion exchange resin during polymerization.

22. A process as defined in claim 8, wherein the polyoxymethylene-siloxane block copolymer has the following formula: 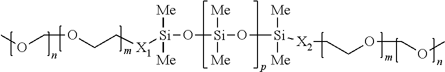
wherein n is from about 5 to about 1500, m is from 2 to 10, p is from 5 to 500, and wherein 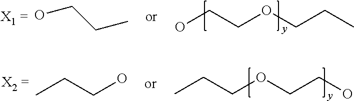
and wherein y is from about 5 to about 50.

23. A process as defined in claim 8, wherein the polyoxymethylene-siloxane block copolymer has the following formula: 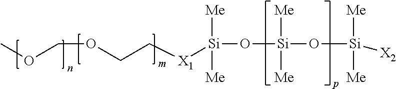
wherein n is from about 5 to about 1500, m is from 2 to 10, p is from 5 to 500, and wherein 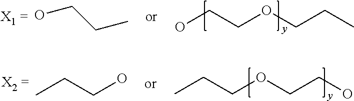
and wherein y is from about 5 to about 50.

24. A process as defined in claim 8, wherein the polymer is formed with an induction period of less than about 100 seconds, and generally greater than about 4 seconds.
